(19) United States
(12) Patent Application Publication
(10) Pub. No.: US 2013/0141084 A1
(43) Pub. Date: Jun. 6, 2013

(54) ELECTROMAGNETIC INPUT DEVICE AND ELECTROMAGNETIC INPUT PANEL

(71) Applicants: KUAN-HONG HSIEH, Tu-Cheng (TW); CHIU-HSIUNG LIN, Tu-Cheng (TW); WEI-GUO XIAO, Shenzhen City (CN); YI-YING CHEN, Tu-Cheng (TW)

(72) Inventors: KUAN-HONG HSIEH, Tu-Cheng (TW); CHIU-HSIUNG LIN, Tu-Cheng (TW); WEI-GUO XIAO, Shenzhen City (CN); YI-YING CHEN, Tu-Cheng (TW)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/334,069

(22) Filed: Dec. 22, 2011

(30) Foreign Application Priority Data
Dec. 2, 2011 (CN) 201110395107.7

(51) Int. Cl. G01B 7/14

(52) U.S. Cl. 324/207.16

(57) ABSTRACT

An electromagnetic input device includes a handheld magnetized stylus, an electromagnetic input panel including an induction layer, a controller, and a storage device. The induction layer includes a plurality of closed-loop inductor coils which output an induced current when experiencing the magnetic flux of the stylus. The storage device stores a pre-determined table recording mapping relationship between location coordinates of the stylus on the electromagnetic input panel in each of the inductor coils, and intensities of the corresponding induced current generated therein. The controller determines which inductor coil generates the induced current, and the intensity of the induced current, and further determines the location of the stylus on the electromagnetic input panel based upon determined inductor coil which generates the induced current and the intensity of the induced current generated therein, and the pre-determined table.

### BACKGROUND

1. Technical Field

The present disclosure relates to input devices and, particularly, to an electromagnetic input device and an electromagnetic input panel.

2. Description of the Related Art

Touch screens are common in electronic devices, and such touch input devices include an electromagnetic touch panel and a magnetized pen for operating the touch panel. However, the electromagnetic touch panel includes a plurality of inductor coils, and every two adjacent coils of the plurality of inductor coils may be arranged on two different layers, thus resulting in unnecessary thickness, excessive heat buildup, and power being wasted in the touch input devices.

Therefore, there is room for improvement within the art.

### BRIEF DESCRIPTION OF THE DRAWINGS

The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a schematic view of an electromagnetic input device, according to an exemplary embodiment.

FIG. 2 is a schematic view of an induction layer of the electromagnetic input device of FIG. 1.

FIG. 3 is a block diagram of the electromagnetic input device of FIG. 1.

FIG. 4 is a schematic view of an induction layer having a plurality of groups of inductor coils of FIG. 2, which are arranged in an order to parallel to the horizontal axis of the electromagnetic input device of FIG. 1.

### DETAILED DESCRIPTION

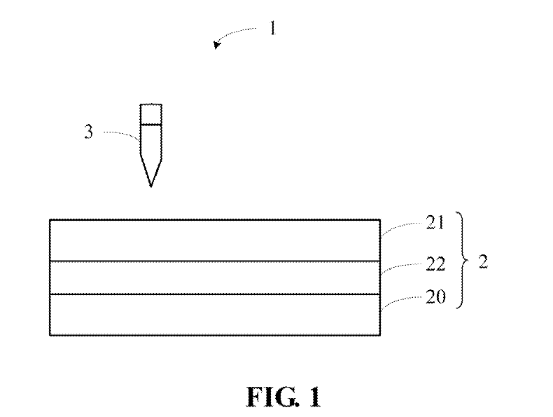

Referring to FIG. 1, an electromagnetic input device 1, according to an exemplary embodiment, includes an electromagnetic input panel 2 and a stylus 3. In this embodiment, the stylus 3 is a magnetized pen, and the electromagnetic input panel 2 is a touch panel, although any input device such as a hand-writing panel is equally applicable and within the scope of the disclosure.

The electromagnetic input panel 2 includes a substrate 20, an induction layer 22, and a cover 21. The induction layer 22 is sandwiched between the substrate 20 and the cover 21.

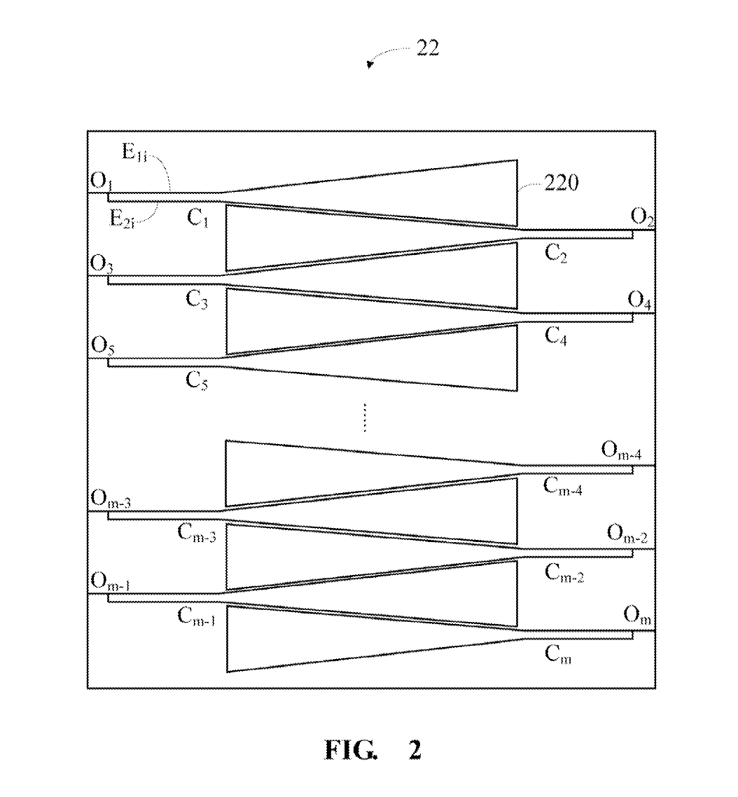

Referring to FIG. 2, the induction layer 22 includes a plurality of first closed-loop inductor coils Cᵢ and a plurality of second closed-loop inductor Cᵢ₊₁, where i=1, 2, . . . m. In the embodiment, each of the first inductor coil Cᵢ and the second inductor coil Cᵢ₊₁ has a substantially triangular shape. The first inductor coil Cᵢ gradually tapers in width along a first direction, and the second inductor coil Cᵢ₊₁ tapers in width along a direction opposite to the first direction. The first inductor coil Cᵢ and the second inductor coil Cᵢ₊₁ are arranged alternately along a second direction perpendicular to the first direction. Each inductor coil Cᵢ includes a first terminal E₁ᵢ and a second terminal E₂ᵢ connected to each other form an output terminal Oᵢ which is opposite to a side 220 of the inductor coil Cᵢ. In this embodiment, the first inductor coil Cᵢ and the second inductor coils Cᵢ₊₁ have a substantially same size. The output terminals Oᵢ of the first inductor coil Cᵢ and the output terminals Oᵢ₊₁ of the second inductor coils Cᵢ₊₁ respectively extend from opposite sides of the first inductor coil Cᵢ and the second inductor coils Cᵢ₊₁, so output terminals O₁, O₃, and O₅ are each adjacent, and output terminals O₂ and O₄ are each adjacent, but the latter group of terminals is on one side and the former group of terminals is on the other side. In the embodiment, the bases of the first triangular inductor coils Cᵢ are parallel with the second direction and aligned with each other, and the bases of the second triangular inductor coils Cᵢ₊₁ are parallel with the second direction and aligned with each other.

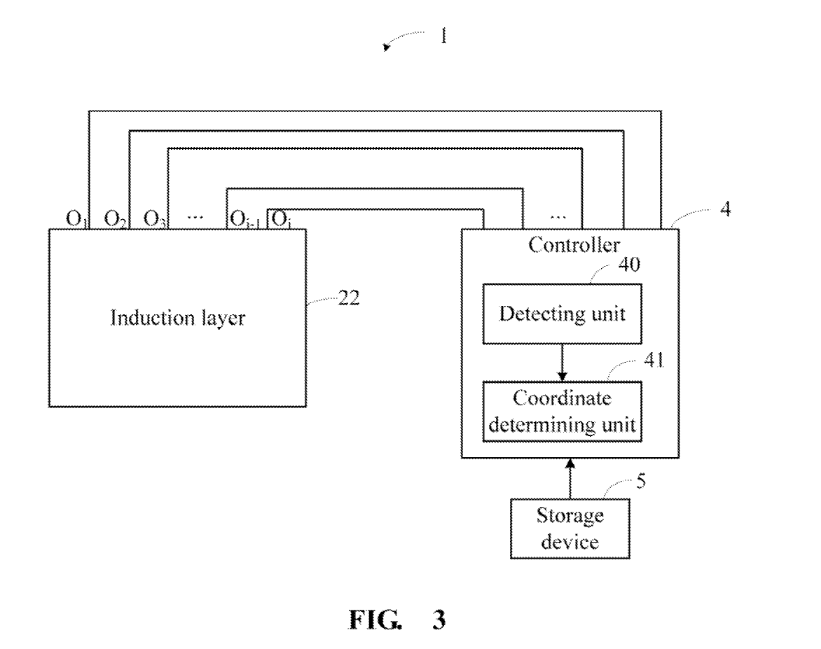

Referring to FIG. 3, the electromagnetic input device 1 further includes a controller 4 and a storage device 5.

The controller 4 includes a detecting unit 40 and a coordinate determining unit 41. The detecting unit 40 is connected to the output terminal Oᵢ. When the stylus 3 is touching, or even in close proximity, and pointing to the first inductor coil Cᵢ and the second inductor coil Cᵢ₊₁, each of the first inductor coil Cᵢ and the second inductor coil Cᵢ₊₁ senses the magnetic flux passing through the coil Cᵢ to generate an induced current Iᵢ. The output terminal Oᵢ is configured to output the induced current Iᵢ to the detecting unit 40. The detecting unit 40 is configured to determine which one of the inductor coil of the coils Cᵢ generates the induced current Iᵢ when receiving the induced current Iᵢ, and further to determine the intensity of the induced current Iᵢ. The manner of determining the intensity of the induced current Iᵢ will be described.

The storage device 5 is connected to the controller 4, and stores a pre-determined table recording mapping relationship between location coordinates of the stylus 3 on the electromagnetic input panel 21 in each of the inductor coils Cᵢ, and intensities of the corresponding inducted current Iᵢ generated therein. In the embodiment, the number of the inductor coils Cᵢ provides the vertical coordinates of the coordinate system of the panel 21, that is, each inductor coil Cᵢ is represented by a particular vertical coordinate of the coordinate system of the panel 21. The triangular shape of the inductor coil Cᵢ ensures that even if the stylus 3 makes contact at different positions within the inductor coil Cᵢ, or has different orientations when making contact, the magnetic flux within the coil Cᵢ will be correspondingly different, thus producing a unique induced current Iᵢ generated by the contact of the stylus. The intensity of the induced current Iᵢ reduces proportionally across the gradually reducing width of the inductor coil Cᵢ, when the stylus 3 is moved from the side 220 towards the output terminal Oᵢ of the inductor coils Cᵢ. Thus, the changing intensity of the induced current Iᵢ precisely reflects the changing of a horizontal coordinate of the stylus 3 in the coordinate system of the panel 21. Therefore, the relationship between the horizontal coordinate value and the induced current Iᵢ of each inductor coil Cᵢ can be predetermined and pre-stored in the storage device 5.

If the stylus 3 points to the inductor coil the magnetic flux through the inductor coil Cᵢ generates an induced current Iᵢ. In practice, the magnetic flux through the inductor coils Cᵢ₋₁, Cᵢ₋₂, . . . and Cᵢ₊₁, Cᵢ₊₂, Cᵢ₊ₕ, where j=1, 2, . . . i−1, and h=1, 2, . . . m−1, which are around the inductor coil may also generate induced currents Iᵢ₋₁, Iᵢ₋₂, . . . and Iᵢ₊₁, Iᵢ₊₂, . . . Iᵢ₊ₕ. However, the induced current Iᵢ of the inductor coil Cᵢ has the largest value or strength of current which is higher than the strengths or intensities of the other currents Iᵢ₋₁, Iᵢ₋₂, . . . Iᵢ₊₁, Iᵢ₊₂, Iᵢ₊ₕ, and therefore the other induced currents Iᵢ₋₁, Iᵢ₋₁, . . . Iᵢ₋ⱼ, Iᵢ₊₁, Iᵢ₊₂, . . . Iᵢ₊ₕ are discarded by the detecting unit 40, and the controller 4 can precisely determine the vertical coordinate of the stylus based on a single induced current Iᵢ.

The coordinate determining unit 41 determines the location of the stylus 3 on the electromagnetic input panel 21 based upon determined inductor coil which generates the induced current Iᵢ and the intensity of the induced current Iᵢ generated therein, and the pre-determined table. In the embodiment, the coordinate determining unit 41 determines the vertical coordinate of the inductor coil Cᵢ which is generating the induced current Iᵢ according to the pre-determined table stored in the storage device 5, and further determine the horizontal coordinate according to the strength or intensity of the induced current Iᵢ, thereby determining the current position of the stylus 3 in the coordinate system of the panel 21.

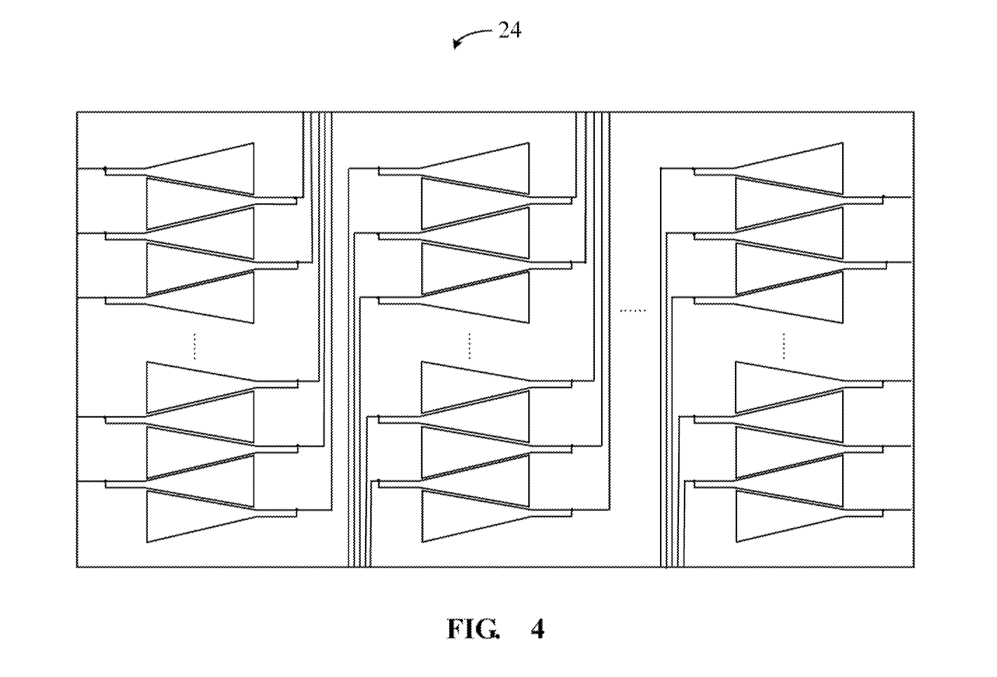

FIG. 4 shows an induction layer 24 of the electromagnetic input device 1 similar to the induction layer 22 as shown in FIG. 1, but further including n groups of additional inductor coils C₁-Cₘ, where n=1, 2, . . . . In this embodiment, each group of additional inductor coils C₁-Cₘ has the same arrangement as that of the inductor coils C₁-Cₘ of the induction layer 22 shown in FIG. 2. The n+1 groups of inductor coils C₁-Cₘ are arranged in an order parallel to the horizontal axis of the coordinate system of the panel 2.

It is understood that the present disclosure may be embodied in other forms without departing from the spirit thereof. The present examples and embodiments are to be considered in all respects as illustrative and not restrictive, and the disclosure is not to be limited to the details given herein.

What is claimed is:

1. An electromagnetic input device, comprising:
a movable magnetized stylus operable to generate a predetermined magnetic field;
an electromagnetic input panel comprising:
an induction layer comprising:
a plurality of first and second closed-loop inductor coils, the first inductor coils gradually tapering in width along a first direction, the second inductor coils gradually tapering in width along a direction opposite to the first direction, the first and second inductor coils arranged alternately along a second direction perpendicular to the first direction, each of the first and second inductor coil being configured to generate an induced current when the stylus is moved adjacent thereto, each inductor coil comprising an output terminal configured to output the induced current;
a storage device configured to store a pre-determined table recording mapping relationship between location coordinates of the stylus on the electromagnetic input panel in each of the inductor coils, and intensities of the corresponding induced current generated therein;
a controller comprising:
a detecting unit connected to the output terminals of the plurality of inductor coils, and configured to determine which one of the inductor coils generates the induced current, and further determine the intensity of the induced current; and
a coordinate determining unit configured to determine the location of the stylus on the electromagnetic input panel based upon determined inductor coil which generates the induced current and the intensity of the induced current generated therein, and the pre-determined table.

2. The electromagnetic input device as recited in claim 1, wherein the first and second inductor coils have a substantially same size.

3. The electromagnetic input device as recited in claim 1, wherein each of the inductor coils comprises a first terminal and a second terminal connected to each other form the output terminal.

4. The electromagnetic input device as recited in claim 1, wherein the output terminals of the first and second inductor coils respectively extend from opposite sides of the first and second inductor coils, as a whole.

5. The electromagnetic input device as recited in claim 4, wherein each of the first and second inductor coils has a substantially triangular shape.

6. The electromagnetic input device as recited in claim 5, wherein the bases of the first triangular inductor coils are parallel with the second direction, and the bases of the second triangular inductor coils are parallel with the second direction.

7. The electromagnetic input device as recited in claim 6, wherein the bases of the first triangular inductor coils are aligned with each other, and the bases of the second triangular inductor coils are aligned with each other.

8. The electromagnetic input device as recited in claim 7, wherein each of the first and second inductor coils forms a substantially equilateral triangle.

9. The electromagnetic input device as recited in claim 1, wherein the electromagnetic input panel further comprises a substrate disposed under the induction layer, and a cover disposed over the induction layer.

10. An electromagnetic input panel comprising:
a substrate;
an induction layer disposed on the substrate, the induction layer comprising a plurality of closed-loop inductor coils, the inductor coils tapering in width along a given direction, the inductor coils arranged in an array, each of the inductor coils being operable to generate an induced current when a magnetic stylus is moved adjacent thereto, each inductor coil comprising an output terminal configured to output the induced current.

11. The electromagnetic input panel as recited in claim 10, further comprising a cover disposed on the induction layer.

12. The electromagnetic input panel as recited in claim 10, wherein the inductor coils having a substantially same shape.

13. The electromagnetic input panel as recited in claim 10, wherein each of the inductor coils comprises a first terminal and a second terminal connected to each other to form the output terminal.

14. The electromagnetic input panel as recited in claim 10, wherein the inductor coils, as a whole, are arranged along a second direction perpendicular to the first direction.
